(19) United States
(12) Patent Application Publication
(10) Pub. No.: US 2020/0112186 A1
(43) Pub. Date: Apr. 9, 2020

(54) CHARGING DISPLAY APPARATUS

(71) Applicant: E Ink Holdings Inc., HSINCHU (TW)

(72) Inventors: Kun-Heng WU, HSINCHU (TW); Feng-Chuan YEH, HSINCHU (TW)

(21) Appl. No.: 16/520,373

(22) Filed: Jul. 24, 2019

(30) Foreign Application Priority Data
Oct. 8, 2018 (TW) 107135439

(51) Int. Cl. H02J 7/00; H02J 7/02; H02J 50/10; H02J 50/80; G06F 1/16

(52) U.S. Cl. CPC H02J 7/0044; H02J 7/025; G06F 1/1601; H02J 50/80; H02J 50/10

(57) ABSTRACT

A charging display apparatus includes a charging unit and a display panel. The charging unit is configured to charge a device. The display panel is disposed over the charging unit and configured to display a charge state of the device, in which the display panel has a plurality of display regions, and each of the display regions is composed of a single display.

### CROSS - REFERENCE TO RELATED APPLICATION

This application claims priority to Taiwan Application Serial Number 107135439, filed Oct. 8, 2018, which is herein incorporated by reference.

### BACKGROUND

### Field of Invention

The present disclosure relates to a charging display apparatus.

### Description of Related Art

Currently, the user roughly recognizes a charge state of the device through light (e.g., LED light), but fails to recognize detailed information of the charge state. If the user wants to recognize the detailed information of the charge state, the device needs to be turned on. In other words, the user cannot recognize the detailed information of the charge state by visual observation, which is inconvenient for the user.

### SUMMARY

A purpose of the present disclosure is to provide a charging display apparatus, which includes a charging unit and a display panel. The display panel can directly display the detailed information of the charge state of the device, and thus can solve the problems described in the prior art.

The present disclosure provides a charging display apparatus, which includes: a charging unit configured to charge a device; and a display panel disposed over the charging unit and configured to display a charge state of the device.

According to some embodiments of the present disclosure, the charging unit comprises a wireless charging coil, a USB slot, or a combination thereof.

According to some embodiments of the present disclosure, the charge state comprises a charging progress, an estimated charging completion time, or a combination thereof.

According to some embodiments of the present disclosure, the charging progress comprises an icon of quantity of electricity, a percentage of quantity of electricity, or a combination thereof.

According to some embodiments of the present disclosure, the display panel is further configured to display a wirelessly chargeable region.

According to some embodiments of the present disclosure, the charging unit is configured to wirelessly charge the device through the display panel.

According to some embodiments of the present disclosure, the charging unit comprises a microcontroller electrically connected to the display panel.

According to some embodiments of the present disclosure, the charging unit comprises a demodulating circuit electrically connected to the microcontroller, and the demodulating circuit is configured to receive the charge state of the device and transmit it to the microcontroller.

According to some embodiments of the present disclosure, the display panel is an electrophoretic display, an organic light emitting diode display, or a liquid crystal display.

According to some embodiments of the present disclosure, the display panel is disposed over the charging unit, and the display panel has a plurality of display regions, and each of the display regions is composed of a single display.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a charging display apparatus according to some embodiments of the present disclosure;

FIG. 2 is a schematic diagram of a charging display apparatus according to some embodiments of the present disclosure; and

FIG. 3 is a schematic diagram showing the charging unit and the device according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “over” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A purpose of the present disclosure is to provide a charging display apparatus, which includes a charging unit and a display panel. The display panel can directly display the detailed information of the charge state of the device, and thus can solve the problems described in the prior art.

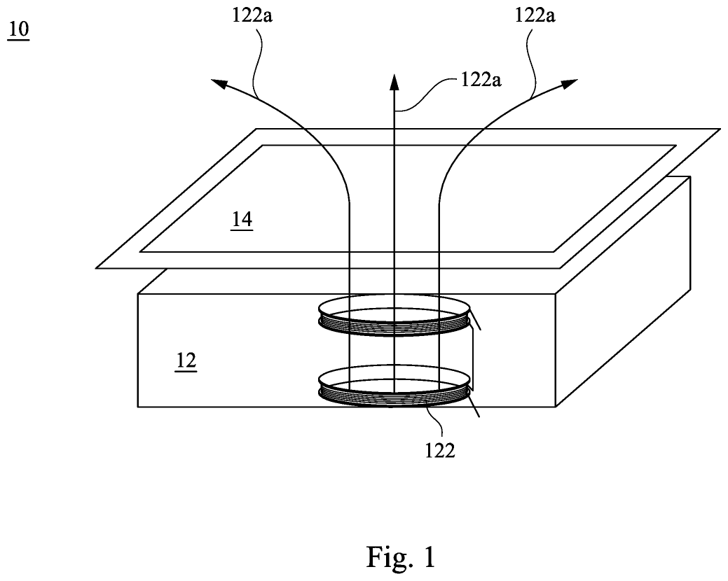

FIG. 1 is a schematic diagram of a charging display apparatus according to some embodiments of the present disclosure. As shown in FIG. 1, the charging display apparatus 10 includes a charging unit 12 and a display panel 14. The charging display apparatus 10 can charge a device (not shown in FIG. 1). The device may be, for example, a portable device such as a cell phone, tablet or notebook computer.

The charging unit 12 is configured to charge the device. In some embodiments, the charging unit 12 is a charging platform. In some embodiments, the charging unit 12 has a housing having a flat upper surface. In some embodiments, the charging unit 12 is configured to wirelessly through the display panel 14 to wirelessly charge the device over the display panel 14. In some embodiments, the charging unit 12 includes a wireless charging coil 122 disposed within the housing. The wireless charging coil 122 may generate electromagnetic waves 122a passing through the display panel 14 to perform a wireless charging function on the device.

The display panel 14 is located over the charging unit 12 and configured to display the charge state of the device. The display panel 14 is an electrophoretic display, an organic light emitting diode display, a liquid crystal display or other suitable display, but not limited thereto.

In some embodiments, the display panel 14 is disposed over the charging unit 12. In some embodiments, the display panel 14 is placed or fixed over the charging unit 12. In some embodiments, a lower surface of the display panel 14 faces the upper surface of the charging platform 12. In some embodiments, the lower surface of the display panel 14 is in contact with the upper surface of the charging platform 12.

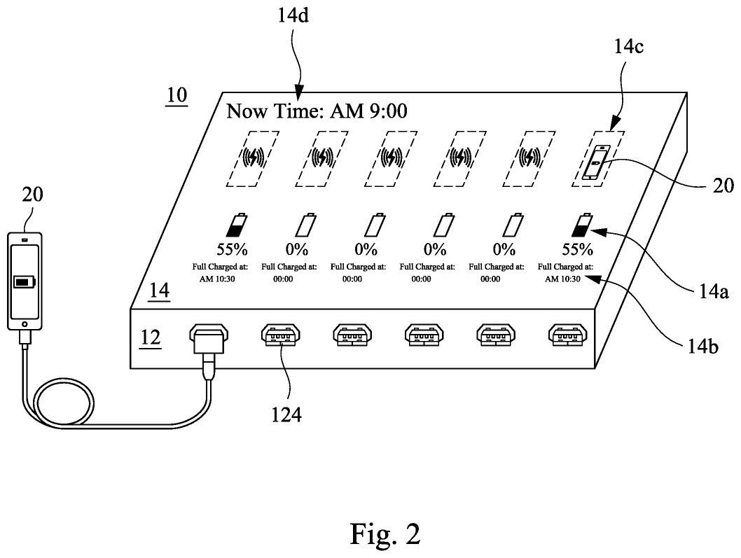

FIG. 2 is a schematic diagram of a charging display apparatus according to some embodiments of the present disclosure. In some embodiments, as shown in FIG. 2, the display panel 14 is configured to display the charge state of the device 20. For example, the charge state of the device 20 may include a charging progress 14a, an estimated charging completion time 14b, other information, or a combination thereof. In some embodiments, the charging progress 14a includes an icon of quantity of electricity (e.g., the battery icon of quantity of electricity, as shown in FIG. 2), a percentage of quantity of electricity, or a combination thereof. In some embodiments, the display panel 14 may be further configured to display one or more wirelessly chargeable regions 14c. In some embodiments, the display panel 14 may be further configured to display current time 14d.

In the present embodiment, the display panel 14 has a plurality of display regions, and each of the display regions is composed of a single display. That is, in the present embodiment, the display panel 14 is a single display panel that divides into a plurality of display regions to display charge states of a plurality of devices 20. In other embodiments, the display panel 14 may also be composed of a plurality of display panels, and each of the display panels displays a charge state of one of the plurality of devices 20.

In some embodiments, the charging unit 12 includes a wireless charging coil 122 (as shown in FIG. 1), a USB slot 124 (as shown in FIG. 2), or a combination thereof. As shown in FIG. 2, the device 20 may also be connected to the charging unit 12 through an USB cable and the USB slot 124 to charge the device 20. In some embodiments, the charging display apparatus 10 may be placed in a public area, such as an airport or station, for charging multiple devices.

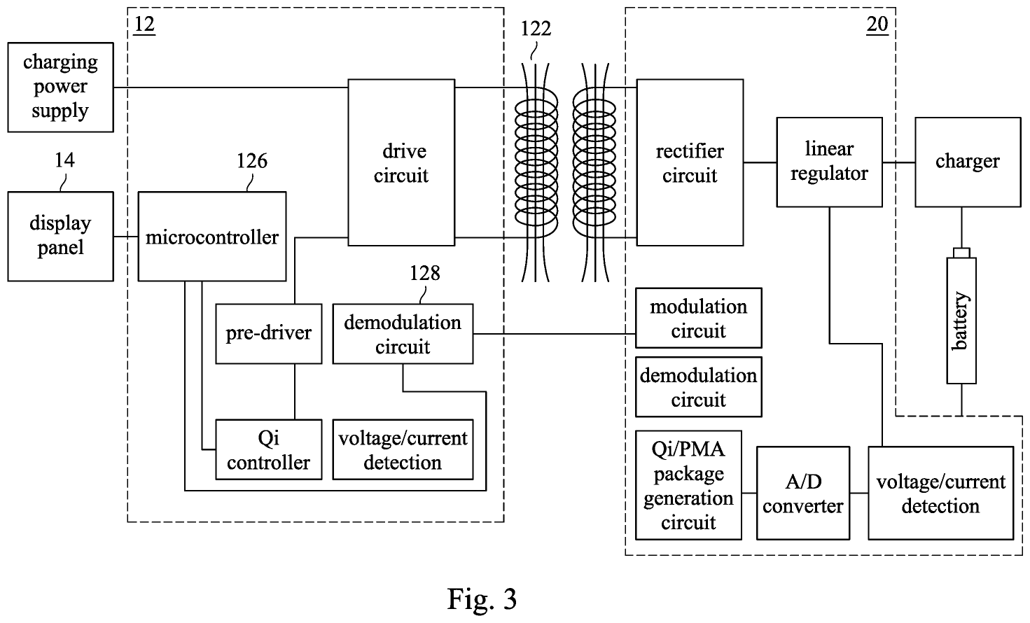

FIG. 3 is a schematic diagram showing the charging unit and the device according to some embodiments of the present disclosure. As shown in FIG. 3, the device 20 is wirelessly charged by the wireless charging coil 122 of the charging unit 12. In some embodiments, the charging unit 12 includes a microcontroller 126 electrically connected to the display panel 14. In some embodiments, the charging unit 12 includes a demodulation circuit 128 electrically connected to the microcontroller 126. The demodulation circuit 128 and the demodulation circuit of the device 20 may wirelessly communicate with each other to receive the charge state of the device 20 and then transmit it to the microcontroller 126. The charge state of the device 20 is then transmitted to the display panel 14 through the microcontroller 126, causing the display panel 14 to display the detailed information of the charge state of the device 20. Since the display panel 14 can directly display the detailed information of the charge state of the device 20, the user does not need to turn on the device, which is convenient for the user.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A charging display apparatus, comprising:
a charging unit configured to charge a device; and
a display panel disposed over the charging unit and configured to display a charge state of the device, wherein the display panel has a plurality of display regions, and each of the display regions is composed of a single display.

2. The charging display apparatus of claim 1, wherein the charging unit comprises a wireless charging coil, a USB slot, or a combination thereof.

3. The charging display apparatus of claim 1, wherein the charge state comprises a charging progress, an estimated charging completion time, or a combination thereof.

4. The charging display apparatus of claim 3, wherein the charging progress comprises an icon of quantity of electricity, a percentage of quantity of electricity, or a combination thereof.

5. The charging display apparatus of claim 1, wherein the display panel is further configured to display a wirelessly chargeable region.

6. The charging display apparatus of claim 1, wherein the charging unit is configured to wirelessly charge the device through the display panel.

7. The charging display apparatus of claim 1, wherein the charging unit comprises a microcontroller electrically connected to the display panel.

8. The charging display apparatus of claim 7, wherein the charging unit comprises a demodulating circuit electrically connected to the microcontroller, and the demodulating circuit is configured to receive the charge state of the device and transmit it to the microcontroller.

9. The charging display apparatus of claim 1, wherein the display panel is an electrophoretic display, an organic light emitting diode display, or a liquid crystal display.
